(19) United States
(12) Patent Application Publication
(10) Pub. No.: US 2008/0210445 A1
(43) Pub. Date: Sep. 4, 2008

(54) Bracket for golf green plow

(75) Inventor: Randall Craig Paulson, Maple Grove, MN (US)

Correspondence Address: SCHWEGMAN, LUNDBERG & WOESSNER, P.A., P.O. BOX 2938, MINNEAPOLIS, MN, 55402, US

(73) Assignee: Par Aide Products Co., Lino Lakes, MN (US)

(21) Appl. No.: 12/002,335

(22) Filed: Dec. 14, 2007

Related U.S. Application Data
(60) Provisional application No. 60/874,779, filed on Dec. 14, 2006.

(51) Int. Cl. A01B 59/06

(52) U.S. Cl. 172/1; 172/21

(57) ABSTRACT

A bracket for a greens mower plow.

### CROSS-REFERENCE TO RELATED APPLICATIONS

This application claims the benefit under 35 U.S.C. 119 (e) of U.S. Provisional Application No. 60/874,779, filed on Dec. 14, 2006, which is hereby incorporated by reference in its entirety.

### FIELD OF THE INVENTION

This invention relates to the field of golf green maintenance, and more specifically to a bracket for a golf green plow.

### BACKGROUND

The greens on a golf course are sometimes aerated to improve the growth of grass on the green. Aerating results in plugs of earth that litter the surface of the green. These plugs can be difficult to remove. A golf green plow can be used to push the plugs off of the green. The plow mounts to a greens mower and is pushed across the green. However, different manufacturers of greens mowers have different front ends making the mounting of a plow difficult.

### BRIEF DESCRIPTION OF THE DRAWINGS

FIG. 1 shows a greens mower with attached plow, in accordance with one embodiment.

FIG. 2 shows a right side mounting bracket, in accordance with one embodiment.

FIG. 3 shows a left side mounting bracket, in accordance with one embodiment.

FIG. 4 shows a perspective view of a right side mounting bracket, in accordance with one embodiment.

FIG. 5 shows a perspective view of a greens plow and mounting brackets, in accordance with one embodiment.

FIG. 6 shows a mounting bracket, in accordance with one embodiment.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

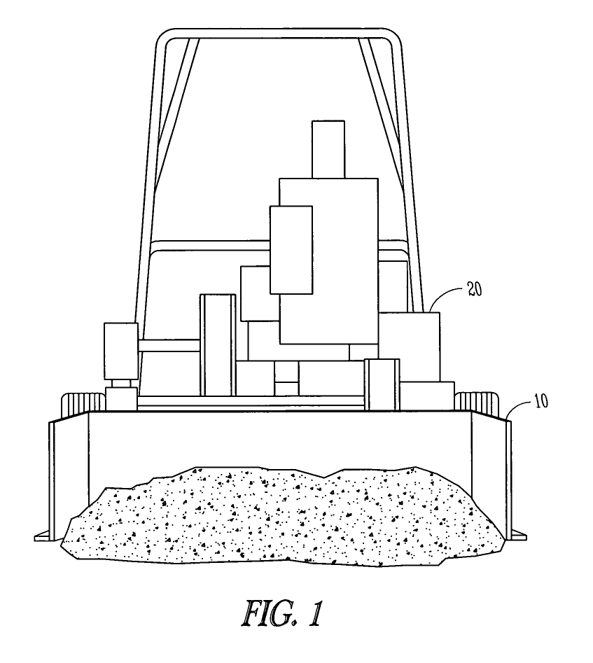

FIG. 1 shows a plow 10 mounted to a greens mower 20. Plow 10 is mounted to the greens mower for easy clearing of greens after aerification. Plow 10 mounts to various walk-behind greens mowers, such as mower 10, with one universal bracket system, as will be discussed below. Using plow 10, the aerification plugs are pushed into large piles for easier clean up. Thus, the time required for aerification is cut drastically.

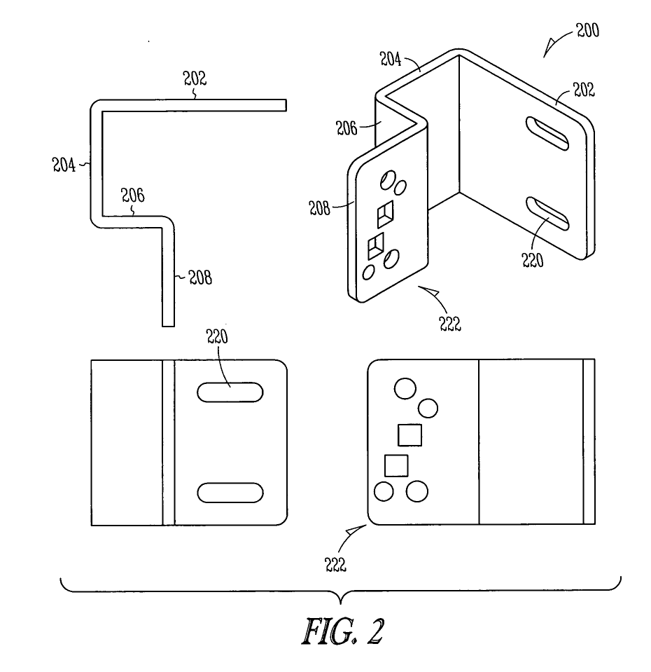

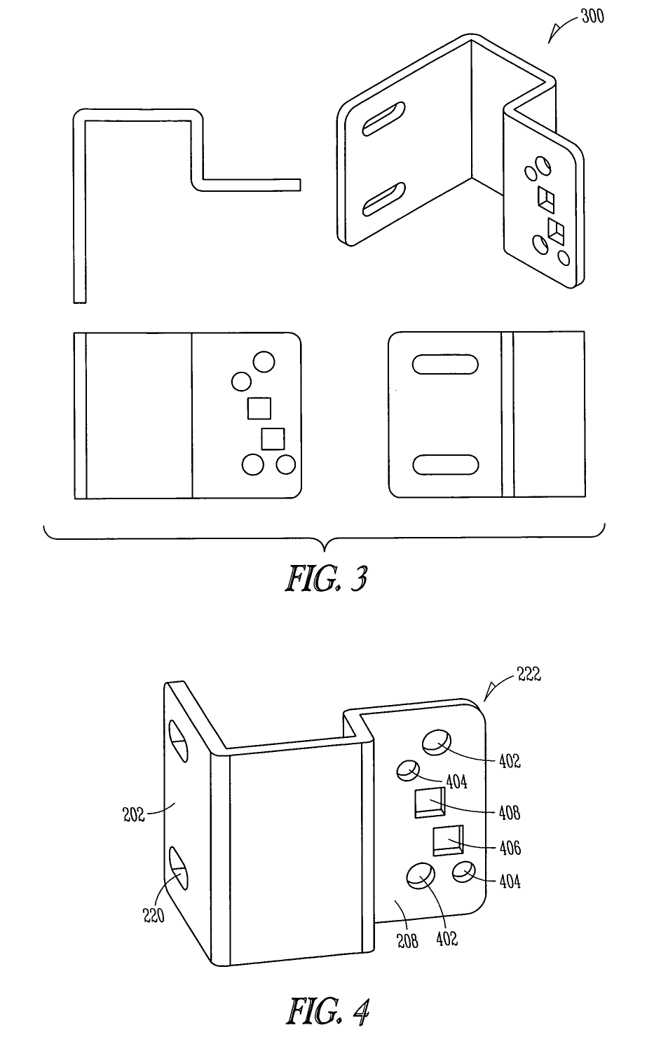

The present bracket system to mount the plow to the mower includes a right side mounting bracket 200 and a left side mounting bracket 300, as shown in FIGS. 2 and 3, respectively. FIG. 2 shows a right side mounting bracket 200 for mounting plow 10 to a greens mower. FIG. 3 shows a bracket 300. Bracket 300 is a left side mounting bracket and is a mirror image of bracket 200. Bracket 200 generally includes a front wall 202 for mounting to the plow, a side wall 204 extending 90 degrees from front wall 202, a wall 206 extending perpendicular from wall 204 and running parallel to front wall 202, and a mower mounting wall 208 extending perpendicular from wall 206.

Front wall 202 includes a plow mounting section including slots 220, for example. Mounting wall 208 includes a mower mounting section 222. Mower mounting section 222 includes assorted round holes and square holes designed and positioned on wall 208 so as to allow the bracket 200 to be mounted interchangeably to one of a wide variety of greens mowers.

Brackets 200 and 300 are interchangeably and selectively usable with a wide variety of greens mowers. For example, they can be used to mount a plow to the Toro Greensmaster 1000, the Jacobsen PGM 22, and the John Deere 220, 220A and 180A greens mowers.

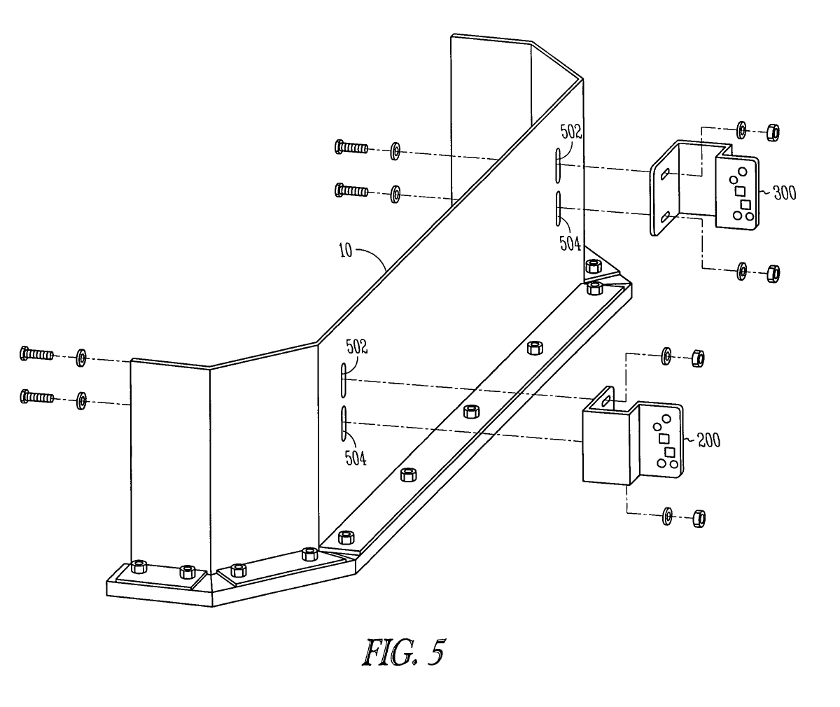

FIG. 4 shows a perspective view of right side mounting bracket 200, in accordance with one embodiment. For example, holes 402 can be used to mount the bracket to a Toro 1000, holes 404 can be used to mount the bracket to a John Deere 220A, square hole 406 can be used to mount the bracket to a John Deere 220, and square hole 408 can be used to mount the bracket to a Jacobsen PGM 22. In other embodiments, one or more or holes 402, 404, 406, and 408 may be omitted. In some embodiments, additional holes can be added to wall 208 for optional mounting of bracket to different greens mowers not specifically mentioned herein.

FIG. 5 shows a perspective view of greens plow 10 and mounting brackets 200, 300, in accordance with one embodiment. To mount the brackets 200, 300 to a mower, brackets 200, 300 can be bolted to slots 502, 504 in plow blade 10 using two ¼-20×1″ bolts, two nylon lock nuts and four flat washers for each bracket, for example. In one embodiment, the bracket 200, 300 mounts interchangeably to the frame rails on one of four walk behind greens mowers discussed above and below.

### Mounting Instructions

For Toro Greensmaster 1000, Jacobsen PGM 22 and John Deere 220A:
1. Remove the catch basket mounting horns from the greens mower.
2. Attach the Left and Right Mount Brackets 200, 300 to the mower frame rails at the holes discussed in FIG. 4, reusing the catch basket mounting hardware.
3. Tip the front of the mower off the ground approximately ½″ and shim to maintain this position.
4. Place the plow blade 10 assembly in front of the mower, against the Left and Right Mount Brackets 300, 200. The plow blade 10 assembly should be flush on the ground.
5. Attach the plow blade 10 Assembly to the Left and Right Mounting Brackets 300, 200 using the hardware per FIG. 5.
6. Tighten all mounting hardware to prevent movement of the plow during use.

### For John Deere 220:

1. Remove the hardware used to fasten the front roller height adjustment assembly to the greens mower frame rail from the left side only.
2. Attach the plow Left Mount Bracket 300 to the mower frame rail, reusing the front roller height adjustment assembly hardware.
3. Remove the hardware and attach the Right Mount Bracket 200 using the same method as used for the Left Bracket 300 in steps 1 and 2.
4. Place the plow blade 10 assembly in front of the mower, against the Left and Right Mount Brackets 300, 200. The plow blade 10 assembly should be flush on the ground.
5. Attach the plow blade 10 assembly to the Left and Right Mounting Brackets 300, 200 using the hardware per FIG. 5.
6. Tighten all mounting hardware to prevent movement of the plow during use.

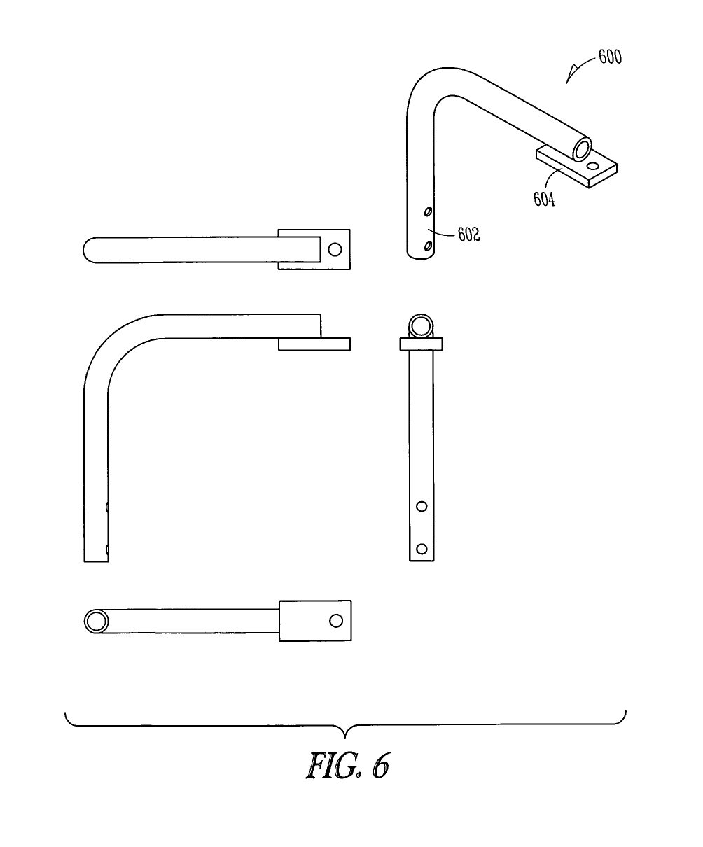

FIG. 6 shows a mounting bracket 600, in accordance with one embodiment. Two brackets 600 can be used to mount a plow 10 (FIG. 1) to a Toro Flex 21 mower, for example. Bracket 600 includes a first end 602 for mounting to the plow and a second end 604 for mounting to the mower.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A bracket comprising:
a first mounting section to mount interchangeably to at least two different greens mowers and a second mounting section to mount to a plow.

2. The bracket of claim 1, wherein the first mounting section includes a first set of holes configured to mount to a John Deere 220A, a second set of holes configured to mount to a Toro Greensaver 1000, a first square hole to mount to a John Deere 220, and a second square hole to mount to a Jacobsen PGM 22.

3. The bracket of claim 2, wherein the second mounting section includes a pair of slots.

4. A plow system for a green comprising:
a plow; and
a bracket coupled to the plow, the bracket for mounting the plow to a greens mower, the bracket including a mounting section including a plurality of mounting holes configured and arranged to mount the bracket alternatively to at least two different greens mower.

5. The plow system of claim 4, wherein the mounting section includes a first set of holes configured to mount to a John Deere 220A, a second set of holes configured to mount to a Toro Greensaver 1000, a first square hole to mount to a John Deere 220, and a second square hole to mount to a Jacobsen PGM 22.

6. A method comprising:
providing a bracket having a plurality of mounting holes configured and arranged to mount the bracket alternatively to a plurality of different greens mowers; and
selectively choosing one or more of the plurality of mounting holes and mounting the bracket to a selected greens mower.

7. The method of claim 6, wherein the plurality of mounting holes include a first set of holes configured to mount to a John Deere 220A, a second set of holes configured to mount to a Toro Greensaver 1000, a first square hole to mount to a John Deere 220, and a second square hole to mount to a Jacobsen PGM 22.
